(19) United States
(12) Patent Application Publication
(10) Pub. No.: US 2006/0109412 A1
(43) Pub. Date: May 25, 2006

(54) Liquid crystal display

(76) Inventors: Shu-Chan Hsiao, Hsinhua (TW); Bing-Jei Liao, Hsinhua (TW); Chung-Yuan Liu, Hsinhua (TW)

Correspondence Address: RABIN & Berdo, PC, 1101 14TH STREET, NW, SUITE 500, WASHINGTON, DC, 20005, US

(21) Appl. No.: 11/239,124

(22) Filed: Sep. 30, 2005

(30) Foreign Application Priority Data
Nov. 23, 2004 (TW) 93136063

(51) Int. Cl. G02F 1/1343

(52) U.S. Cl. 349/146

(57) ABSTRACT

A liquid crystal display (LCD) includes a substrate and several pixel electrodes. The pixel electrodes are formed on the substrate. Each of pixel electrodes has at least a cut corner, and there is no black matrix between the pixel electrodes.

This application claims the benefit of Taiwan application Serial No. 93136063, filed Nov. 23, 2004, the subject matter of which is incorporated herein by reference.

### BACKGROUND OF THE INVENTION

1. Field of the Invention

The invention relates in general to a liquid crystal display (LCD), and more particularly to an LCD in which pixel electrodes have cut corners and no black matrixes are disposed between pixel electrodes.

2. Description of the Related Art

Liquid crystal on silicon (LCOS) small-scale display having the advantages of small size, low power consumption and high resolution has been widely used in consumer electronic products such as projectors and rear-projection TV.

The LCOS small-scale display has smaller pixel area, therefore, the size of the pixel electrodes and the interval between the pixel electrodes are smaller than those of an ordinary thin film transistor liquid crystal display (TFT-LCD). As shown in FIG. 1, LCOS display 100 has several pixel electrodes 120 formed on a substrate 110. The size of the pixel electrode 120 can be 12 μm×12 μm for instance, and the interval between the pixel electrodes 120 can be 0.5 μm for instance, smaller than the interval of pixel electrodes in an ordinary TFT-LCD, which is equal to 2 μm. Therefore, when the driving voltages of adjacent two pixel electrodes 120 are different, for instance, a normal-mode driving voltage of 5V is inputted to a pixel electrode 120, and a black-mode driving voltage of 1.8V is inputted to an adjacent pixel electrode 120, a significant fringing field Ef would occur between the two adjacent pixel electrodes 120.

The fringing field Ef affects the normal alignment of liquid crystal molecules (not shown in the diagram) around the pixel electrode 120, resulting in the light-leakage of black-mode pixels and insufficient luminance of normal-mode pixels. Since the LCOS display 100 has no black matrix (not shown in the diagram) between the pixel electrodes 120 to avoid these problems, severely jeopardizing the display quality of images of the LCOS display 100. Therefore, how to effectively reduce the fringing field effect occurring between the pixel electrodes in response to the miniaturization of LCD has become an imminent challenge.

### SUMMARY OF THE INVENTION

It is therefore the object of the invention to provide a liquid crystal display (LCD). By using the design of pixel electrodes having cut corners, the above-mentioned fringing field effect can be reduced, thereby improving the display quality of the LCD.

According to an object of the invention, an LCD including a substrate and several pixel electrodes is provided. The pixel electrodes are formed on the substrate. Each of the pixel electrodes has at least a cut corner, and there is no black matrix between the pixel electrodes.

According to an object of the invention, a liquid crystal on silicon (LCOS) display, including a substrate and several pixel electrodes is provided. The pixel electrodes are formed on the substrate, and each of the pixel electrodes has at least a cut corner.

According to an object of the invention, an LCD including a substrate and several pixel electrodes is provided. The pixel electrodes are formed on the substrate, and at least one of the pixel electrodes has at least two cut corners.

The design of the cut corner is capable of reducing the fringing field effect generated between the pixel electrodes.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a structural diagram of pixel electrode alignment of a conventional LCD;

FIG. 2A is a simplified structural side-view of an LCD according to a preferred embodiment of the invention;

FIG. 2B is a schematic diagram of the shape and alignment of the pixel electrodes of FIG. 2A;

FIG. 2C is a schematic diagram of two adjacent red and green pixel electrodes having cut corners of FIG. 2B;

FIG. 3 is a comparison diagram among the R-V curves of the LCD pixels according to a preferred embodiment of the invention, the conventional LCD single color pixels, and the conventional LCD pixels displaying a white image;

FIG. 4 is a structural diagram of pixel electrodes of strip alignment according to a preferred embodiment of the invention; and

FIG. 5 is a structural diagram of pixel electrodes of Mosaic alignment according to a preferred embodiment of the invention.

### DETAILED DESCRIPTION OF THE INVENTION

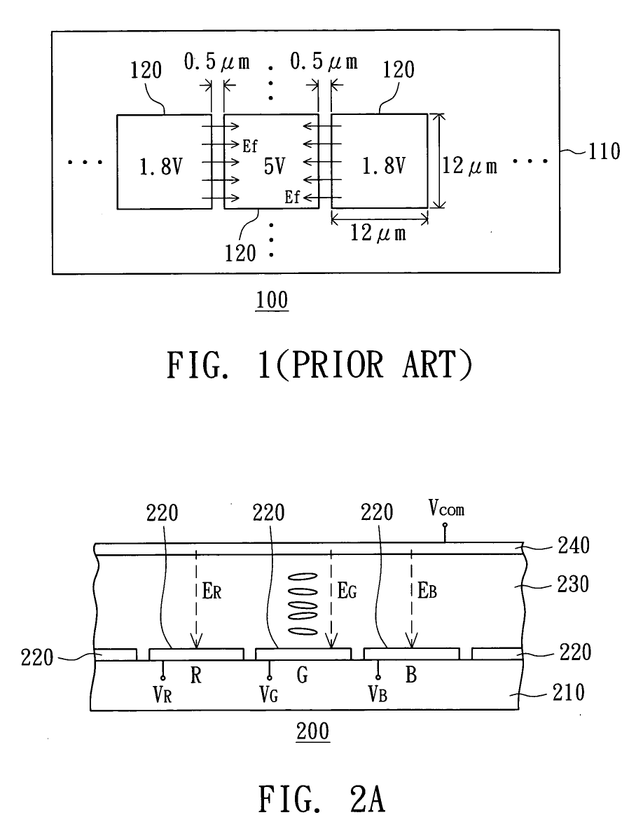

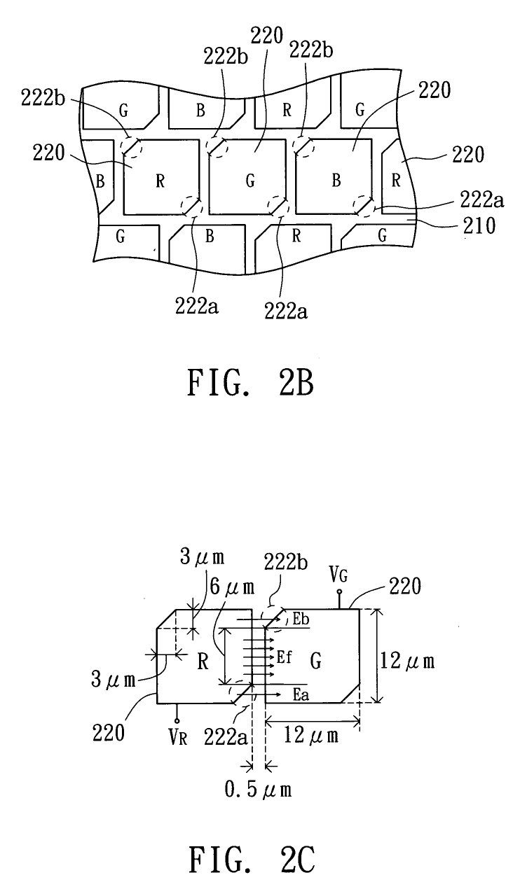

Referring to FIG. 2A, a simplified structural side-view of an LCD according to a preferred embodiment of the invention is shown. LCD 200, which can be for instance a LCOS small-scale display, includes a substrate 210, pixel electrodes 220, a liquid crystal layer 230 and a common electrode 240. The pixel electrodes 220 include red (R) pixel electrodes, green (G) pixel electrodes and blue (B) pixel electrodes. By using the longitudinal electric fields ER, EG, EB generated by the driving voltages VR, VG, VB of the pixel electrodes 220 and the driving voltage VCOM of the common electrode 240, the liquid crystal molecules of the liquid crystal layer 230 are driven to rotate to provide corresponding display.

Referring to FIG. 2B, a schematic diagram of the shape and alignment of the pixel electrodes of FIG. 2A is shown. Take the delta (Δ) alignment of the R, G, and B pixels for instance. As shown in FIG. 2B, the red pixel electrodes 220, the green pixel electrodes 220 and the blue pixel electrodes 220 form a type of delta alignment. The pixel electrodes 220 are a kind of rectangular electrode plate, and each of the pixel electrodes 220 has two cut corners 222a (bottom right) and 222b (top left) positioned in the same diagonal direction (from top left to bottom right). The cut corners 222a and 222b can be a triangular corner for instance.

Referring to FIG. 2C, a schematic diagram of two adjacent red and green pixel electrodes 220 having cut corners 222a and 222b of FIG. 2B is shown. The size of the adjacent red and green pixel electrodes 220 can be 12 μm×12 μm for instance. The interval between the red and green pixel electrode 220 can be 0.5 μm for instance. The cut corners 222a and 222b, for instance, can have a shape of an equilateral triangle whose side-length equals 3 μm. Obviously, the corner-cut red pixel electrode 220 has only a 6 μm electrode edge distant from the adjacent corner-cut green pixel electrode 220 by 0.5 μm. The top right edge of the red pixel electrode 220 has a distance larger than 0.5 μm with the cut corner 222b of the green pixel electrode 220 while the cut corner 222a of the red pixel electrode 220 has a distance larger than 0.5 μm with the bottom left edge of the green pixel electrode 220.

As the interval between the adjacent electrode plates becomes wider, the effect of the generated electrical field becomes smaller. Therefore, the horizontal electrical field Ea formed on the cut corner 222a region of the red pixel electrode 220 and the horizontal electrical field Eb formed on the cut corner 222b region of the green pixel electrode 220 by the driving voltage VR of the red pixel electrode 220 and the drive voltage VG of the green pixel electrode 220 are smaller than the horizontal electrical field Ef formed on the adjacent region of the red and green pixel electrodes 220 whose interval is 0.5 μm. So, the pixel electrodes 220 whose shape is designed to have cut corners 222a and 222b helps to reduce the fringing field effect generated by the pixel electrode 220.

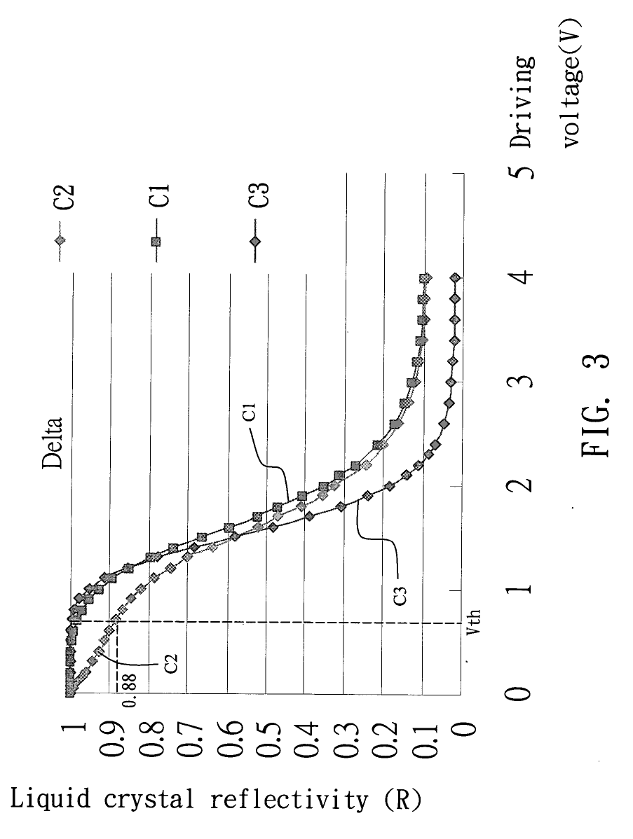

Referring to FIG. 3, a comparison diagram among the R-V curves of the LCD pixels according to a preferred embodiment of the invention, the conventional LCD single color pixels, and the conventional LCD pixels displaying a white image is shown. The relationship between the liquid crystal reflectivity (R) and the driving voltage (V) when the LCD 200 only displays images by the red, the green or the blue pixels is illustrated by curve C1 of FIG. 3. The R-V relationship when a conventional LCD only displays images by the red, the green or the blue pixels and the R-V relationship when a conventional LCD only displays a white image are respectively illustrated by curve C2 and curve C3 of FIG. 3. It can be seen that when the driving voltage V is smaller than the threshold voltage Vth, the liquid crystal reflectivity R of LCD 200 can reach as high as 100% like the display of a white image. The liquid crystal reflectivity R only reaching 88% when the conventional LCD displays by single color pixels implies that the light-leakage issue of black-mode pixels and insufficient-luminance issue of normal-mode pixels can be improved by the design of pixel electrodes 220 having electrode cut corners 220a and 220b. The picture displayed by the red, green, and blue pixels whose reflectivity approximates 100% would be even close to a white image, and hence the quality of image display of LCD can be effectively improved.

Despite the invention is exemplified by a triangular cut corner and the two cut corners formed in the same diagonal direction, however, the invention is not limited thereto. The cut corner formed in other shapes such as a rectangular, arc or polygonal cut corner is within the scope of the invention as long as the corner of the electrode plate is not rectangular after corner cut. Each pixel electrode having the same number of or different number of cut corners such as one, two or three cut corners is within the scope of the invention and so is the cut corner of each pixel electrode being positioned in different four corners within the scope of of the invention as long as each pixel electrode has at least a cut corner, which helps to mitigate the horizontal electrical field of adjacent pixel electrodes and reduces the conventional fringing field effect.

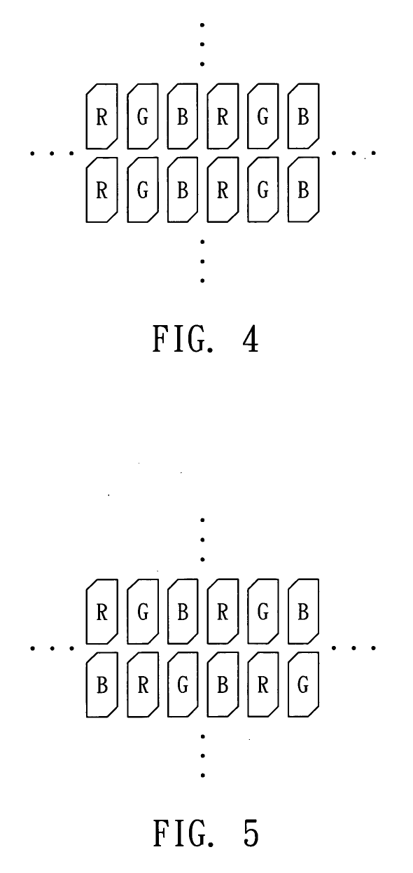

Despite the invention is exemplified by the delta alignment of pixels, the design of introducing a cut corner to the pixel electrode of the invention is applicable to other types of pixel alignment such as the strip alignment of FIG. 4 or the Mosaic alignment of FIG. 5. The design of the invention is also applicable to a twisted nematic (TN) type LCD and a vertical alignment (VA) type LCD. As long as the pixel electrode is incorporated with appropriate cut corner design, the fringing field effect can be effectively mitigated.

The LCD disclosed in above embodiment of the invention has advantage of effectively reducing the fringing field effect generated between the pixel electrodes and resolving the light-leakage problem of black-mode pixels and the insufficient-luminance problem of normal-mode pixels to improve the display quality of LCD by forming a cut corner on each pixel electrode through simple modification in the structure of the pixel electrode such as through the change in the shape of the pixel electrode.

While the invention has been described by way of example and in terms of a preferred embodiment, it is to be understood that the invention is not limited thereto. On the contrary, it is intended to cover various modifications and similar alignments and procedures, and the scope of the appended claims therefore should be accorded the broadest interpretation so as to encompass all such modifications and similar alignments and procedures.

What is claimed is:

1. A liquid crystal display (LCD), comprising:
a substrate; and
a plurality of pixel electrodes formed on the substrate, wherein each of the pixel electrodes has at least a cut corner and there is no black matrix between the pixel electrodes.

2. The LCD according to claim 1, wherein the cut corner is a triangular corner.

3. The LCD according to claim 1, wherein the cut corner is a rectangular corner.

4. The LCD according to claim 1, wherein the cut corner is a polygonal corner.

5. The LCD according to claim 1, wherein the cut corner is an arc corner.

6. The LCD according to claim 1, wherein the cut corner is not rectangular.

7. The LCD according to claim 1, wherein each of the pixel electrodes has two cut corners positioned in the same diagonal direction.

8. The LCD according to claim 1, wherein each of the pixel electrodes has four cut corners.

9. The LCD according to claim 1, wherein the pixel alignment of the LCD is one of strip alignment, delta (Δ) alignment and Mosaic alignment.

10. The LCD according to claim 1, wherein the liquid crystal operating mode of the LCD is a twisted nematic (TN) type.

11. The LCD according to claim 1, wherein the liquid crystal operating mode of the LCD is a vertical alignment (VA) type.

12. The LCD according to claim 1, being a liquid crystal on silicon (LCOS) display.

13. A liquid crystal on silicon (LCOS) display, comprising:
a substrate; and
a plurality of pixel electrodes formed on the substrate, wherein each of the pixel electrodes has at least a cut corner.

14. The LCOS display according to claim 13, wherein the cut corner is one of triangular corner, rectangular corner, polygonal corner and arc corner.

15. The LCOS display according to claim 13, wherein the cut corner is not rectangular.

16. The LCOS display according to claim 13, wherein at least one of the pixel electrodes has two cut corners positioned in a diagonal direction.

17. The LCOS display according to claim 13, wherein at least one of the pixel electrodes has four cut corners.

18. The LCOS display according to claim 13, wherein the pixel alignment of the LCD is one of strip alignment, delta (Δ) alignment and Mosaic alignment.

19. The LCOS display according to claim 13, wherein the liquid crystal operating mode of the LCD is a twisted nematic (TN) type.

20. The LCOS display according to claim 13, wherein the liquid crystal operating mode of the LCD is a vertical alignment (VA) type.

21. A liquid crystal display (LCD), comprising:
a substrate; and
a plurality of pixel electrodes formed on the substrate, wherein at least one of the pixel electrodes has at least two cut corners.

22. The LCD according to claim 21, wherein the cut corner is one of triangular corner, rectangular corner, polygonal corner and arc corner.

23. The LCD according to claim 21, wherein the cut corner is not rectangular.

24. The LCD according to claim 21, wherein the two cut corners positioned in a diagonal direction.

25. The LCD according to claim 24, wherein the diagonal direction is top left to bottom right.

26. The LCD according to claim 24, wherein the diagonal direction is top right to bottom left.

27. The LCD according to claim 21, wherein the pixel alignment of the LCD is one of strip alignment, delta (Δ) alignment and Mosaic alignment.

28. The LCD according to claim 21, wherein the liquid crystal operating mode of the LCD is a twisted nematic (TN) type.

29. The LCD according to claim 21, wherein the liquid crystal operating mode of the LCD is a vertical alignment (VA) type.
